(19) United States
(12) Patent Application Publication
(10) Pub. No.: US 2022/0220976 A1
(43) Pub. Date: Jul. 14, 2022

(54) COOLING SYSTEM FOR CENTRIFUGAL COMPRESSOR AND REFRIGERATION SYSTEM INCLUDING SAME

(71) Applicant: Emerson Climate Technologies, Inc., Sidney, OH (US)

(72) Inventors: Michael M. Perevozchikov, Tipp City, OH (US); Matthew J. Swallow, Versailles, OH (US)

(21) Appl. No.: 17/248,166

(22) Filed: Jan. 12, 2021

(51) Int. Cl. F04D 29/58; H02K 5/173; H02K 9/193; H02K 5/20; F04D 25/06; F04D 29/28

(52) U.S. Cl. CPC F04D 29/5806; H02K 5/1732; F04D 29/284; H02K 5/20; F04D 25/06; H02K 9/193

(57) ABSTRACT

A cooling system for a compressor includes a coolant supply line, a coolant return line, a temperature sensor connected to the coolant return line to detect at least one of a temperature of the coolant return line and a temperature of coolant within the coolant return line, and a controller. The coolant supply line includes a coolant control valve, and is connectable to a housing of the compressor to deliver coolant to at least one of a plurality of coolant flow channels defined therein. The coolant return line is connectable to the compressor housing to receive coolant from the coolant flow channels and return coolant to a low-pressure side of the compressor. The controller is configured to control the coolant control valve based on the temperature detected by the temperature sensor to control the supply of coolant through the coolant supply line.

### FIELD

The field relates generally to centrifugal compressors, and more particularly, to cooling and refrigeration systems for use with centrifugal compressors.

### BACKGROUND

Centrifugal compressors have several advantages over positive displacement compressor designs, such as reciprocating, rotary, scroll, and screw compressors, but the incorporation of centrifugal compressors in lower-capacity cooling systems is limited due to the high rotation speed of the impeller of a centrifugal compressor and the associated challenges of providing a suitable operating environment for the impeller and associated motor. One particular challenge is providing sufficient cooling to the motor and bearings associated with the compressor driveshaft to maintain the motor and bearings within a suitable range of operating temperatures.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

In one aspect, a compressor system includes a centrifugal compressor and a cooling circuit. The compressor includes a housing, a shaft rotatably supported in the housing by at least one bearing, an impeller connected to the shaft, and a motor operably connected to the shaft. The housing has a plurality of coolant flow channels defined therein that delivers coolant to the bearing and the motor. The cooling circuit includes a coolant supply line connected to the compressor housing to deliver coolant to at least one of the plurality of coolant flow channels. The coolant supply line includes a coolant control valve to control coolant flow through the coolant supply line. The cooling circuit also includes a coolant return line connected to the compressor housing to receive coolant from the plurality of coolant flow channels and return coolant to a low-pressure side of the compressor, a temperature sensor connected to the coolant return line to detect at least one of a temperature of the coolant return line and a temperature of coolant within the coolant return line, and a controller connected to the temperature sensor and the coolant control valve. The controller is configured to control the coolant control valve based on the temperature detected by the temperature sensor to control the supply of coolant to the compressor housing.

In another aspect, a cooling system for a compressor includes a coolant supply line, a coolant return line, a temperature sensor connected to the coolant return line to detect at least one of a temperature of the coolant return line and a temperature of coolant within the coolant return line, and a controller. The coolant supply line includes a coolant control valve to control coolant flow therethrough, and is connectable to a housing of the compressor to deliver coolant to at least one of a plurality of coolant flow channels defined within the compressor housing. The coolant return line is connectable to the compressor housing to receive coolant from the plurality of coolant flow channels and return coolant to a low-pressure side of the compressor. The controller is connected to the temperature sensor and the coolant control valve, and is configured to control the coolant control valve based on the temperature detected by the temperature sensor to control the supply of coolant through the coolant supply line.

In yet another aspect, a refrigeration system includes a compressor, an evaporator, a condenser, an expansion device, and a cooling circuit. The compressor includes a housing, a shaft rotatably supported in the housing by at least one bearing, an impeller connected to the shaft, and a motor operably connected to the shaft. The housing has a plurality of coolant flow channels defined therein that delivers coolant to the at least one bearing and the motor. The cooling circuit includes a coolant supply line connected to the compressor housing to deliver coolant to at least one of the plurality of coolant flow channels, a coolant return line connected to the compressor housing to receive coolant from the plurality of coolant flow channels and return coolant to a low-pressure side of the compressor, a temperature sensor connected to the coolant return line to detect at least one of a temperature of the coolant return line and a temperature of coolant within the coolant return line, and a controller. The coolant supply line includes a coolant control valve to control coolant flow through the coolant supply line. The controller is connected to the temperature sensor and the coolant control valve, and is configured to control the coolant control valve based on the temperature detected by the temperature sensor to control the supply of coolant to the compressor housing.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The following figures illustrate various aspects of the disclosure.

FIG. 1 is a schematic diagram of an example refrigeration system.

FIG. 2 is a schematic diagram of an example compressor cooling system suitable for use in the refrigeration system of FIG. 1

FIG. 3 is a sectional view of a portion of the compressor cooling system shown in FIG. 2, showing a temperature sensor connected to a coolant return line.

FIG. 4 is a graph illustrating operation of a coolant control valve of the compressor cooling system shown in FIG. 2 based on two temperature set points.

FIG. 5 is a schematic diagram of another example compressor cooling system suitable for use in the refrigeration system 100 of FIG. 1.

FIG. 6 is a graph illustrating operation of coolant control valves of the compressor cooling system shown in FIG. 5 based on an example control scheme.

FIG. 7 is a perspective view of an assembled compressor suitable for use in the refrigeration system of FIG. 1 and the compressor cooling systems of FIGS. 2 and 5.

FIG. 8 is a cross-sectional view of the compressor of FIG. 7 taken along line 8-8.

Corresponding reference characters indicate corresponding parts throughout the drawings.

### DETAILED DESCRIPTION

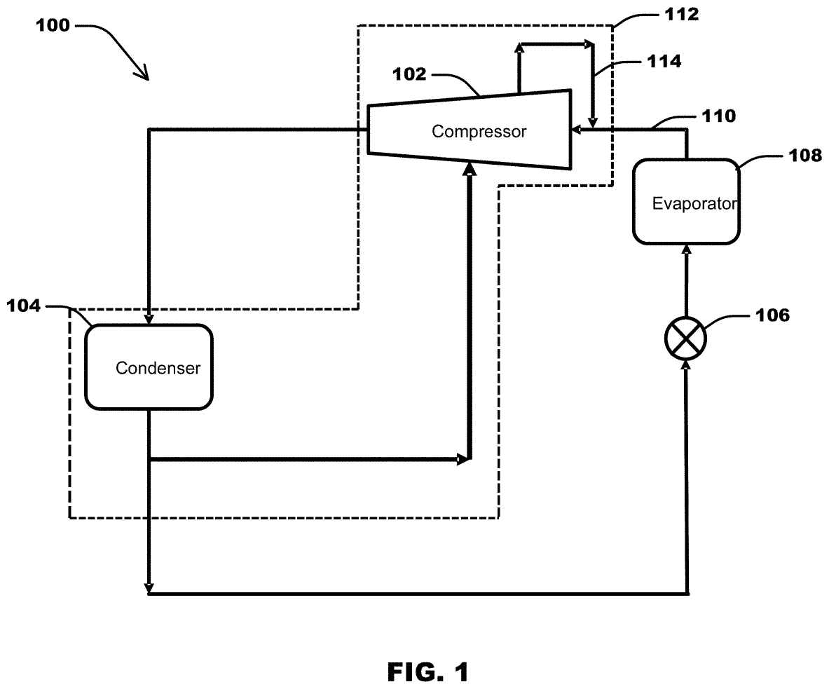

FIG. 1 is a schematic diagram of an example refrigeration system 100. The refrigeration system 100 includes a centrifugal compressor 102, a condenser 104, an expansion device 106 (e.g., an expansion valve, orifice, capillary tube), and an evaporator 108. The refrigeration system 100 may include additional components or other components than those shown and described with reference to FIG. 1 without departing from the scope of the present disclosure. In operation, the compressor 102 receives a working fluid, such as a refrigerant, as a low pressure gas through a suction line 110. The compressor 102 compresses the gas, thereby raising the temperature and pressure of the gas. The pressurized, high temperature gas then flows to the condenser 104, where the high pressure gas is condensed to a high pressure liquid. The liquid then flows through an expansion device 106 that reduces the pressure of the liquid. The reduced pressure fluid, which may be a gas or a mixture of gas and liquid after passing through the expansion device 106, then passes through the evaporator 108. The evaporator 108 may include a heat exchanger, with a fluid circulating therethrough that is cooled by the reduced pressure refrigerant fluid as the refrigerant fluid evaporates to a gas in the evaporator 108. The refrigerant gas is then directed back to the compressor 102 via the suction line 110, where the working fluid is again compressed and the process repeats.

The example refrigeration system 100 includes a compressor cooling system 112 that draws working fluid from part of the refrigerant circuit (downstream of the condenser 104 in this example), and directs it to the compressor 102 to cool components of the compressor 102, such as a motor and bearings of the compressor 102. The working fluid used in the cooling system 112, referred to as “coolant”, is returned to the refrigeration circuit by a coolant return line 114 that has an outlet connected to a low pressure side of the compressor 102 (e.g., the suction line 110). As described further herein, the pressure differential across the cooling circuit of the cooling system 112 drives coolant through the compressor 102, and back into the refrigeration circuit.

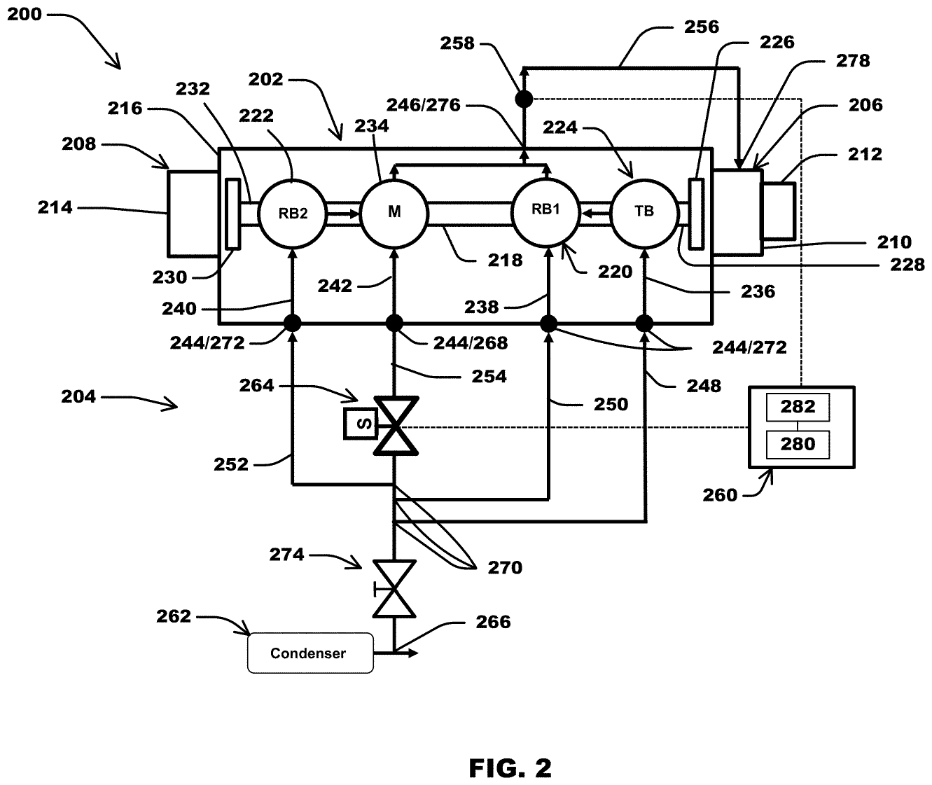

FIG. 2 is a schematic diagram of an example compressor cooling system 200 suitable for use in the refrigeration system 100 of FIG. 1. The compressor cooling system 200 includes a compressor 202 (e.g., compressor 102) and a cooling circuit 204 configured to deliver coolant to components of the compressor 202 to facilitate cooling the compressor 202 and maintaining components of the compressor 202 within suitable operating temperature ranges.

The compressor 202 of the illustrated embodiment is a two-stage centrifugal compressor 202 that includes a first stage 206 and a second stage 208. In other embodiments, the compressor 202 may include a single stage or may include more than two stages. In yet other embodiments, the compressor 202 may be a compressor other than a centrifugal compressor. The first stage 206 includes a first stage inlet 210 that is connected in fluid communication with an evaporator (e.g., evaporator 108, shown in FIG. 1) by a suction line 212. The second stage 208 includes a second stage inlet 214 that is connected in fluid communication with a first stage outlet of the first stage 206 by a refrigerant transfer conduit (not shown in FIG. 2) to receive compressed refrigerant from the first stage 206.

The compressor 202 generally includes a housing 216, a shaft 218 rotatably supported in the housing 216 by a plurality of bearings 220, 222, 224, a first stage impeller 226 connected to a first end 228 of the shaft 218, a second stage impeller 230 connected to a second end 232 of the shaft 218, and a motor 234 operably connected to the shaft 218 to drive rotation thereof. The compressor 202 may include components in addition to those shown in FIG. 2.

The housing 216 encloses components of the compressor 202 within one or more sealed (e.g., hermetically or semi-hermitically) cavities. In some embodiments, for example, the housing 216 includes end caps at each stage of the compressor 202 that define volutes in which the first and second stage impellers 226, 230 are positioned. In some embodiments, the housing 216 is formed from a plurality of cast pieces that are assembled using suitable fasteners (e.g., screws, bolts, etc.)

The bearings 220, 222, 224 rotatably support the shaft 218 within the housing 216. In the illustrated embodiment, the compressor 202 includes a first radial bearing 220, a second radial bearing 222, and a thrust bearing 224. In other embodiments, the compressor 202 may include additional or fewer bearings. The bearings 220, 222, 224 may include any suitable type of bearings that enable the compressor 202 to function as described herein including, for example and without limitation, roller-type bearings, magnetic bearings, fluid film bearings, air foil bearings, and combinations thereof. In the illustrated embodiment, each of the bearings 220, 222, 224 comprises an air foil type bearing.

The motor 234 is operably connected to the shaft 218 to drive rotation thereof during operation of the compressor 202. The motor 234 may generally include any suitable motor that enables the compressor 202 to function as described herein. In the illustrated embodiment, the motor 234 is an electric motor and includes suitable components (e.g., a stator and a rotor) to impart rotational motion to the shaft 218 during operation of the compressor 202.

The housing 216 has a plurality of coolant flow channels 236, 238, 240, 242 defined therein that delivers coolant to the plurality of bearings 220, 222, 224 and the motor 234. The plurality of coolant flow channels 236, 238, 240, 242 may be arranged and/or defined within the compressor housing 216 in any manner that enables the compressor cooling system 200 to function as described herein. For example, the coolant flow channels 236, 238, 240, 242 may be formed as passages in components (e.g., cast components, as by machining, for example) of the compressor housing 216, as passages defined between two or more components of the compressor 202 (e.g., between the motor 234 and the compressor housing 216), and combinations thereof.

The example compressor 202 includes a first coolant flow channel 236, a second coolant flow channel 238, a third coolant flow channel 240, and a fourth coolant flow channel 242. The first coolant flow channel 236 delivers coolant to the thrust bearing 224, the second coolant flow channel 238 delivers coolant to the first radial bearing 220, the third coolant flow channel 240 delivers coolant to the second radial bearing 222, and the fourth coolant flow channel 242 delivers coolant to the motor 234. In some embodiments, the coolant flow channels 236, 238, 240, 242 may share common or overlapping portions. In the illustrated embodiment, for example, the first coolant flow channel 236 overlaps with and feeds into the second coolant flow channel 238 at the first radial bearing 220, and the third coolant flow channel 240 overlaps with and feeds into the fourth coolant flow channel 242 at the motor 234.

Each of coolant flow channels 236, 238, 240, 242 has a corresponding coolant inlet port 244 that connects to the cooling circuit 204 in the example embodiment. That is, the compressor housing 216 includes four external inlet connections for connecting the plurality of coolant flow channels 236, 238, 240, 242 to the cooling circuit 204. In other embodiments, the compressor housing 216 may have fewer external inlet connections. For example, two or more of the coolant flow channels 236, 238, 240, 242 may share a common, single coolant inlet port (and a common connection point to the cooling circuit 204) that provides coolant to multiple of the coolant flow channels 236, 238, 240, 242. In such embodiments, coolant flow delivered to the common coolant inlet port may be separated, divided, or otherwise routed within the compressor housing 216 to deliver coolant to two or more of the coolant flow channels 236, 238, 240, 242. In some embodiments, for example, the bearing coolant flow channels (i.e., the first, second, and third coolant flow channels 236, 238, 240) may have a common coolant inlet port, and the coolant flow may be routed to the separate flow channels internally within the compressor housing 216.

The compressor housing 216 also defines a common coolant outlet port 246 in the illustrated embodiment. The common coolant outlet port 246 receives coolant from each of the plurality of coolant flow channels 236, 238, 240, 242. In other words, all of the coolant delivered to the compressor housing 216 and the coolant flow channels 236, 238, 240, 242 is returned to the common coolant outlet port 246. In some embodiments, at least one of the plurality of coolant flow channels 236, 238, 240 is arranged such that coolant flows through at least one coolant flow channel, in series, across at least one of the bearings 220, 222, 224, through the motor 234, and to the common coolant outlet port 246. In this way, coolant flowing through the at least one coolant flow channel absorbs heat from both the motor 234 and one of the bearings 220, 222, 224. Coolant may flow through the motor 234, for example, by flowing between a stator and a rotor of the motor 234, through a portion of the shaft 218 around which the motor 234 is disposed, and/or through flow channels or holes defined in the rotor of the motor 234.

The cooling circuit 204 delivers coolant to the compressor housing 216 (specifically, to the plurality of coolant flow channels 236, 238, 240, 242) and returns coolant to the refrigeration circuit (e.g., refrigeration system 100 shown in FIG. 1) of which the compressor 202 is a part. The illustrated cooling circuit 204 includes a plurality of coolant supply lines 248, 250, 252, 254, a coolant return line 256, a temperature sensor 258, and a controller 260.

The coolant supply lines 248, 250, 252, 254 are connected in fluid communication with a coolant source 262, and are connected to the compressor housing 216 to deliver coolant to the plurality of coolant flow channels 236, 238, 240, 242. The coolant supply lines 248, 250, 252, 254 can include any suitable fluid conduit (rigid and/or flexible) that enables delivery of coolant to the compressor housing 216 including, for example and without limitation, pipes, hoses, tubes, and combinations thereof In some embodiments, the coolant supply lines 248, 250, 252, 254 are constructed of metal tubing, such as copper tubing. The illustrated cooling circuit 204 includes four coolant supply lines 248, 250, 252, 254, one for each of the coolant flow channels 236, 238, 240, 242 defined within the compressor housing 216. More specifically, the illustrated embodiment includes a plurality of bearing coolant supply lines 248, 250, 252 and a motor coolant supply line 254. Each of the bearing coolant supply lines 248, 250, 252 is connected to one of the first, second, and third coolant flow channels 236, 238, 240 to channel or deliver coolant to at least one of compressor bearings 220, 222, 224. The motor coolant supply line 254 is connected to the fourth coolant flow channel 242 to deliver coolant to the motor 234.

The example coolant source 262 is the refrigeration circuit of which the compressor 202 is a part, specifically, coolant drawn from the refrigeration circuit downstream of a condenser (e.g., condenser 104, shown in FIG. 1) of the refrigeration circuit, such as between the condenser and an expansion device of the refrigeration system. The coolant is the same working fluid (e.g., refrigerant) used in the refrigerant system in the example. In other embodiments, the coolant source 262 may be a portion of the refrigeration system other than downstream of the condenser, such as the condenser, or any other suitable coolant source that enables the compressor cooling system 200 to function as described herein. In yet other embodiments, the coolant source 262 may be an auxiliary liquid cycle.

As explained further herein, coolant is drawn from the coolant source 262 and through the cooling circuit 204 using a pressure differential between the coolant source 262 and an outlet end of the return line 256. In other embodiments, coolant may be directed through the cooling circuit 204 using additional or alternative means, such as a pump.

At least one of the coolant supply lines 248, 250, 252, 254 includes a coolant control valve 264 to control coolant flow through the corresponding coolant supply line. The control valve 264 includes an electrically-actuatable valve that is controllable by the controller 260 to vary or otherwise control the flow rate of coolant through the corresponding supply line. Suitable valves include, for example and without limitation, solenoid valves, electronic expansion valves, and modulating control valves. In the illustrated embodiment, the motor coolant supply line 254 includes the coolant control valve 264. In other embodiments, one or more of the bearing coolant supply lines 248, 250, 252 may include a coolant control valve 264. In yet other embodiments, the motor coolant supply line 254 and one or more of the bearing coolant supply lines 248, 250, 252 may include a coolant control valve 264.

The motor coolant supply line 254 is configured as a primary or main coolant supply line in the illustrated embodiment, having an inlet 266 connected to the coolant source 262 and an outlet 268 connected to the compressor housing 216 to deliver coolant to the fourth coolant flow channel 242. The bearing coolant supply lines 248, 250, 252 are configured as branch lines in the illustrated embodiment, each having an inlet 270 connected to the motor coolant supply line 254 upstream of the coolant control valve 264, and an outlet 272 connected to the compressor housing 216 to deliver the coolant to the first, second, and third coolant flow channels 236, 238, 240. In other embodiments, the inlet 270 of one or more of the bearing coolant supply lines 248, 250, 252 may be connected to the coolant source 262. In yet other embodiments, the motor coolant supply line 254 may be configured as a branch circuit extending off of one of the bearing coolant supply lines 248, 250, 252.

The illustrated cooling circuit 204 also includes a shutoff valve 274 on the main coolant supply line (i.e., the motor coolant supply line 254) to enable coolant flow to the entire cooling circuit to be shut off in order to isolate the compressor from the rest of the system, (e.g., for service). The shutoff valve 274 may be omitted in other embodiments.

In the illustrated embodiment, the bearing coolant supply lines 248, 250, 252 are free of shutoff valves or other devices that would cut the supply of coolant through the bearing coolant supply lines 248, 250, 252. Thus, while the cooling circuit 204 is active, the bearing coolant supply lines 248, 250, 252 are configured to continuously supply coolant to the compressor housing 216, irrespective of a position of the coolant control valve 264. In this way, the bearings of the compressor 202 are continuously supplied with coolant during operation to facilitate maintaining bearings within a suitable range of operating temperatures. The bearing coolant flow paths—including the bearing coolant supply lines 248, 250, 252 and the associated coolant flow channels 236, 238, 240 defined within the compressor housing 216—can include flow restrictors along the flow path to restrict or otherwise limit the flow of coolant therethrough. The flow restrictors may be included in the bearing coolant supply lines 248, 250, 252 and/or may be integrated into the compressor housing 216 (e.g., as metering orifices along the coolant flow channels). In some embodiments, for example, one or more of the coolant inlet ports 244 associated with the bearing coolant flow channels 236, 238, 240 includes a metering orifice to control the flow of coolant therethrough.

The coolant return line 256 is connected to the compressor housing 216 to receive coolant from the plurality of coolant flow channels 236, 238, 240, 242 and return coolant to a low-pressure side of the compressor 202. The low pressure side of the compressor 202 generally refers to portions of the compressor 202 and the refrigeration circuit of which the compressor 202 is a part that precede the compression stages of the compressor 202 (i.e., the first stage 206 and the second stage 208). The low pressure side of the compressor 202 may include, for example and without limitation, a portion of the compressor 202 upstream of the first stage impeller 226, an inlet to the first stage 206, and the suction line 212 connected to the inlet of the first stage 206.

The coolant return line 256 can include any suitable fluid conduit (rigid and/or flexible) that enables delivery of coolant from the compressor housing 216 to the lower pressure side of the compressor 202. Suitable conduits include, for example and without limitation, pipes, hoses, tubes, and combinations thereof. In some embodiments, the coolant return line 256 is constructed of metal tubing, such as copper tubing. In other embodiments, the coolant return line 256 is constructed of other materials. Additionally, in some embodiments, the return line 256 may include a flat portion or section to facilitate mounting the temperature sensor 258.

An inlet 276 of the coolant return line 256 is connected to the common coolant outlet port 246, and an outlet 278 of the coolant return line 256 is connected to the low-pressure side of the compressor 202. Coolant at the coolant source 262 (e.g., the condenser 104) is generally at a higher pressure than the low pressure side of the compressor 202. As a result, a pressure differential exists between coolant at the coolant source 262 and the low pressure side of the compressor 202, which facilitates driving coolant through the cooling circuit 204.

The coolant return line 256 is connected to the common coolant outlet port 246, and receives coolant from each of the plurality of coolant flow channels 236, 238, 240, 242 after the coolant absorbs heat from the motor 234 and/or the bearings 220, 222, 224. As noted above, at least one of the plurality of coolant flow channels 236, 238, 240, 242 can be arranged such that coolant flows through the at least one coolant flow channel, in series, across at least one of the bearings 220, 222, 224, through the motor 234, and to the common coolant outlet port 246. In the illustrated embodiment, for example, the third cooling flow channel 240 is arranged so the coolant flows, in series, across the second radial bearing 222, through the motor 234, and to the common coolant outlet port 246. As a result, coolant that flows through the coolant return line 256 has absorbed heat from at least one of the bearings 220, 222, 224 and the motor 234, even when the coolant control valve 264 is in an off position.

The temperature sensor 258 is connected to the coolant return line 256 to detect at least one of a temperature of the coolant return line 256 and a temperature of coolant within the coolant return line 256. The temperature sensor 258 can include any suitable temperature sensor that enables the cooling circuit 204 to function as described herein, including, for example and without limitation, thermistors, thermocouples, resistance temperature detectors (RTDs), thermal switches, and combinations thereof. In some embodiments, the temperature sensor 258 includes a negative temperature coefficient thermistor.

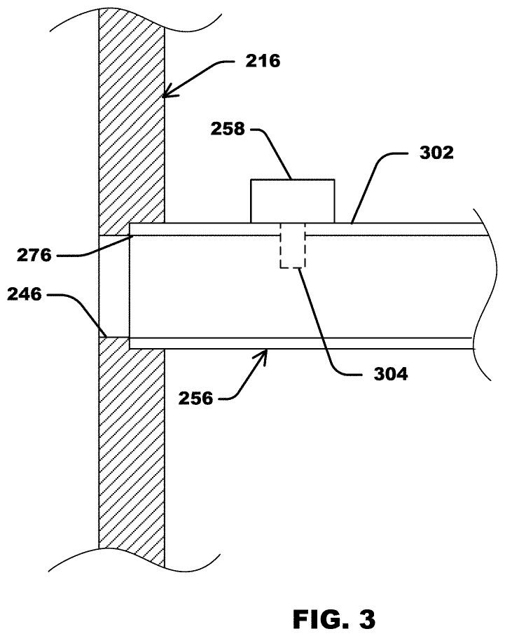

The temperature sensor 258 of this embodiment is located completely external of the compressor housing 216 and the coolant return line 256, and is configured to detect a temperature of the coolant return line 256. As illustrated in FIG. 3, for example, the temperature sensor 258 is connected to an external surface 302 of the coolant return line 256, and is configured to detect a temperature of the external surface 302. In other embodiments, the temperature sensor 258 may include a probe 304 (shown in dashed lines in FIG. 3) that extends within the coolant return line 256 to detect a temperature of coolant flowing through the coolant return line 256.

The controller 260 is connected to the temperature sensor 258 and the coolant control valve 264, and is configured to control operation of the coolant control valve 264 (e.g., by opening, closing, or varying a position of the coolant control valve 264). In some embodiments, for example, the controller 260 is configured to control the coolant control valve 264 based on the temperature detected by the temperature sensor 258 to control the supply of coolant to the compressor housing 216. For example, the controller 260 may receive a signal from the temperature sensor 258 indicative of a temperature detected by the temperature sensor 258, compare the detected temperature to one or more temperature set points, and control the coolant control valve 264 based on the detected temperature.

The controller 260 generally includes any suitable computer and/or other processing unit, including any suitable combination of computers, processing units and/or the like that may be communicatively connected to one another and that may be operated independently or in connection within one another (e.g., controller 260 may form all or part of a controller network). Controller 260 may include one or more modules or devices, one or more of which is enclosed within the compressor 202, or may be located remote from the compressor 202. The controller 260 may include one or more processor(s) 280 and associated memory device(s) 282 configured to perform a variety of computer-implemented functions (e.g., performing the calculations, determinations, and functions disclosed herein). As used herein, the term “processor” refers not only to integrated circuits, but also refers to a controller, a microcontroller, a microcomputer, a programmable logic controller (PLC), an application specific integrated circuit, and other programmable circuits. Additionally, memory device(s) 282 of controller 260 may generally be or include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 282 may generally be configured to store suitable computer-readable instructions that, when implemented by the processor(s), configure or cause controller 260 to perform various functions described herein including, but not limited to, controlling the coolant control valve 264 and/or various other suitable computer-implemented functions.

Controller 260 and/or components of controller 260 may be integrated or incorporated within other components of the cooling circuit 204 and/or a refrigeration system within which the cooling circuit 204 is incorporated. For example, the controller 260 may be incorporated within the coolant control valve 264 and/or a system controller that controls other functions and operations of the compressor 202 and the refrigeration system.

The controller 260 can be configured to control the coolant control valve 264 based solely on temperatures detected by the temperature sensor 258. As noted above, for example, the temperature sensor 258 is configured to detect a temperature of coolant within the coolant return line 256 or the coolant return line 256 itself, which receives coolant from each of the coolant flow channels 236, 238, 240, 242. Further, at least one of the coolant flow channels (e.g., the third coolant flow channel 240) is arranged such that coolant flows across at least one of the bearings 220, 222, 224 and the motor 234 before reaching the common coolant outlet port 246. Consequently, coolant flowing through the coolant return line 256 has absorbed heat from both the compressor bearings 220, 222, 224 and the motor 234. Thus, the temperature of coolant within the coolant return line 256 and the temperature of the coolant return line 256 provides an indication of the temperature of the bearings 220, 222, 224 and the motor 234, and can be used to determine when additional coolant at the motor 234 is needed (and thus the coolant control valve 264 should be opened), or when no additional coolant at the motor 234 is needed (and thus the coolant control valve 264 should be closed).

The controller 260 can be configured to receive a signal from the temperature sensor 258 indicative of a temperature detected by the temperature sensor 258, and compare the detected temperature to one or more temperature set points (stored in the controller memory 282, for example). Based on the comparison, the controller 260 can be configured to open the coolant control valve 264, thereby permitting additional coolant flow through the motor coolant supply line 254 and to the motor 234, or close the coolant control valve 264, thereby reducing coolant flow through the motor coolant supply line 254 and to the motor 234. “Opening” and “closing” the coolant control valve 264 can refer to absolute opening and closing (i.e., completely opening and closing of the valve), or relative opening and closing of the valve (e.g., opening the valve more than it already is, or closing the valve more than it already is).

The one or more temperature set points can be empirically determined prior to operation, for example, by comparing a measured temperature of the motor with the temperature detected by the temperature sensor 258. In some embodiments, for example, a single temperature set point can be determined based on the temperature detected by the temperature sensor when the measured temperature of the motor 234 reaches a maximum allowable operating temperature. In this case, the temperature set point may be set as a temperature that is a certain number of degrees below the temperature detected by temperature sensor 258 (e.g., 10° C., 20° C., 30° C., etc.) when the measured temperature of the motor 234 is at the maximum allowable operating temperature. In embodiments that use a single temperature set point, the controller 260 can open the coolant control valve 264 when the temperature detected by the temperature sensor 258 is above the temperature set point, and close the coolant control valve 264 when the temperature detected by the temperature sensor 258 is below the temperature set point.

The controller 260 may alternatively, or additionally control the coolant control valve 264 based on more than a single temperature set point, such as two temperature set points. In such embodiments, two temperature set points may define a window or range of suitable temperatures. In such embodiments, the controller 260 can open the coolant control valve 264 when the temperature detected by the temperature sensor 258 is above a first, upper temperature set point, and close the coolant control valve 264 when the temperature detected by the temperature sensor 258 is below a second, lower temperature set point.

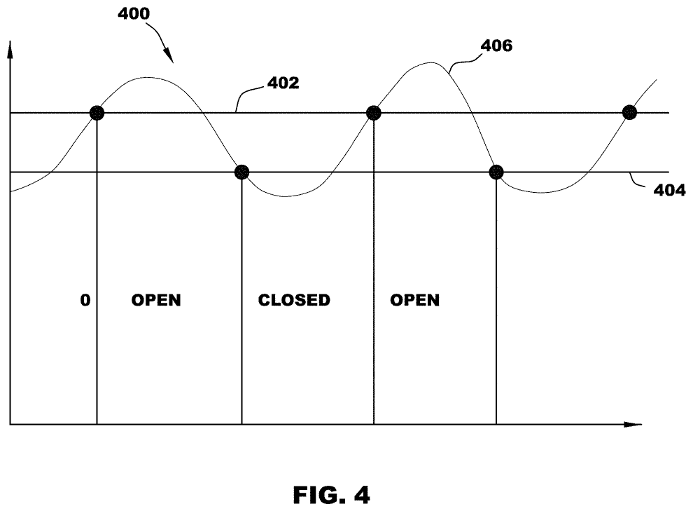

FIG. 4 is a graph 400 illustrating operation of the coolant control valve 264 based on two temperature set points, indicated by lines 402 and 404. The first and second temperature set points 402 and 404 generally define a temperature range above which the coolant control valve 264 is opened, and below which the coolant control valve 264 is closed. The temperature range may be any suitable temperature range that enables the compressor 202 to function as described herein including, for example and without limitation, 2° F., 5° F., 10° F., 15° F., 20° F., 25° F., 30° F., 35° F., 40° F., 50° F., or greater. The temperature detected by the temperature sensor 258 is illustrated by curve 406 in FIG. 4. As shown by FIG. 4, when the detected temperature 406 exceeds the first temperature set point 402, the controller 260 opens the coolant control valve 264 to supply additional coolant to the motor 234. The additional coolant supplied to the motor 234 results in the temperature of coolant in the coolant return line 256 and the temperature of the coolant return line 256 initially increasing as additional heat is picked up from the motor 234 (e.g., from the stator), and subsequently decreasing, resulting in the detected temperature 406 decreasing. When the detected temperature 406 decreases to a temperature below the second temperature set point 404, the controller 260 closes the coolant control valve 264, reducing coolant flow to the motor 234. The temperature of coolant at the coolant return line 256 increases as a result, as shown in FIG. 4. When the detected temperature 406 reaches a temperature that exceeds the first temperature set point 402 again, the controller 260 again opens the coolant control valve 264 to supply additional coolant to the motor 234 and the cycle repeats.

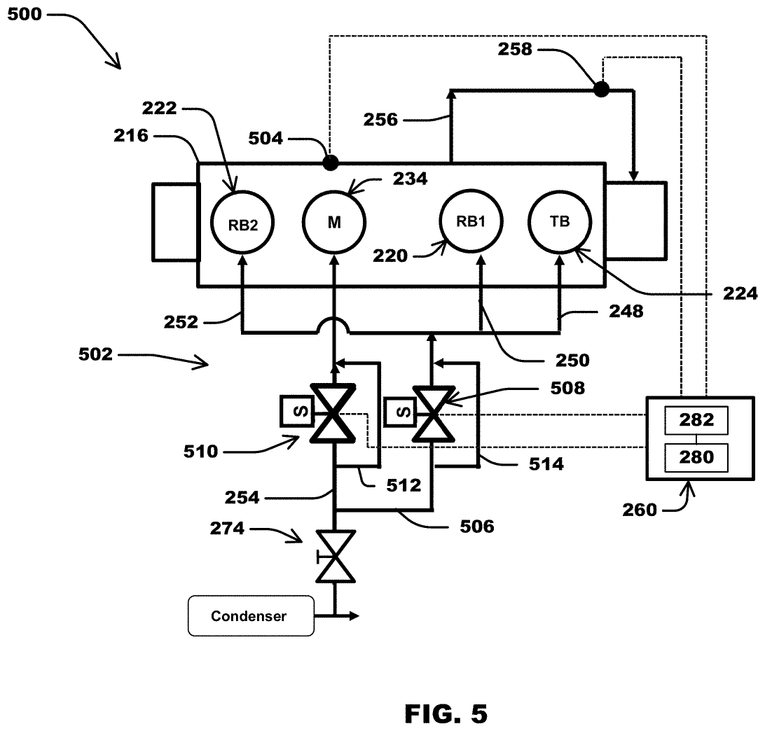

FIG. 5 is a schematic diagram of another example compressor cooling system 500 suitable for use in the refrigeration system 100 of FIG. 1. The compressor cooling system 500 includes a cooling circuit 502 that includes the first temperature sensor 258 connected to the coolant return line 256. Additionally, the cooling circuit 502 includes a second temperature sensor 504 connected to the compressor housing 216 (e.g., a shell of the compressor housing 216) to detect a temperature of the compressor housing 216. The second temperature sensor 504 is connected to an external surface of compressor housing 216 in this embodiment, and is configured to detect a temperature of the external surface.

Further, in this embodiment, the cooling circuit 502 includes a main bearing coolant supply line 506 that branches off of the motor coolant supply line 254, and feeds into each of the plurality of bearing coolant supply lines 248, 250, 252. The main bearing coolant supply line 506 includes a bearing coolant control valve 508 used to control a flow of additional or supplemental coolant flow to the compressor bearings 220, 222, 224, and the motor coolant supply line 254 includes a motor coolant control valve 510 that controls a flow of additional or supplemental coolant flow to the motor 234. More specifically, each of the motor coolant supply line 254 and the main bearing coolant supply line 506 includes a respective bypass line 512, 514. The bypass lines 512, 514 allow coolant to bypass the respective motor coolant control valve 510 and the bearing coolant control valve 508 to provide a continuous flow of coolant to the motor 234 and compressor bearings 220, 222, 224, respectively, irrespective of a position of the motor coolant control valve 510 and the bearing coolant control valve 508. The bypass lines 512, 514 may include a metering orifice or other metering device to limit or regulate the flow of coolant therethrough. The motor coolant control valve 510 may be opened to provide additional or supplemental coolant flow to the motor 234, and the bearing coolant control valve 508 may be opened to provide additional or supplemental coolant flow to the bearings 220, 222, 224.

As shown in FIG. 5, the motor coolant control valve 510 and the bearing coolant control valve 508 are connected to the controller 260. The controller 260 can be configured to control (i.e., open and close) the bearing coolant control valve 508 and the motor coolant control valve 510 based on temperatures detected by the first temperature sensor 258 and the second temperature sensor 504. For example, the controller 260 can be configured to control the bearing coolant control valve 508 based on temperatures detected by the first temperature sensor 258, and control the motor coolant control valve 510 based on temperatures detected by the second temperature sensor 504. In particular, the controller 260 can compare a temperature detected by the first temperature sensor 258 to a first temperature set point associated with the first temperature sensor 258, and open or close the bearing coolant control valve 508 based on the comparison. For example, the controller 260 can open the bearing coolant control valve 508 to provide supplemental coolant flow to the bearings 220, 222, 224 if the temperature detected by the first temperature sensor 258 is above the first temperature set point, and can close the bearing coolant control valve 508 to reduce coolant flow to the bearings 220, 222, 224 if the temperature detected by the first temperature sensor 258 is below the first temperature set point. Similarly, the controller 260 can open the motor coolant control valve 510 to provide supplemental coolant flow to the motor 234 if the temperature detected by the second temperature sensor 504 is above the second temperature set point, and can close the motor coolant control valve 510 to reduce coolant flow to the motor 234 if the temperature detected by the second temperature sensor 504 is below the first temperature set point.

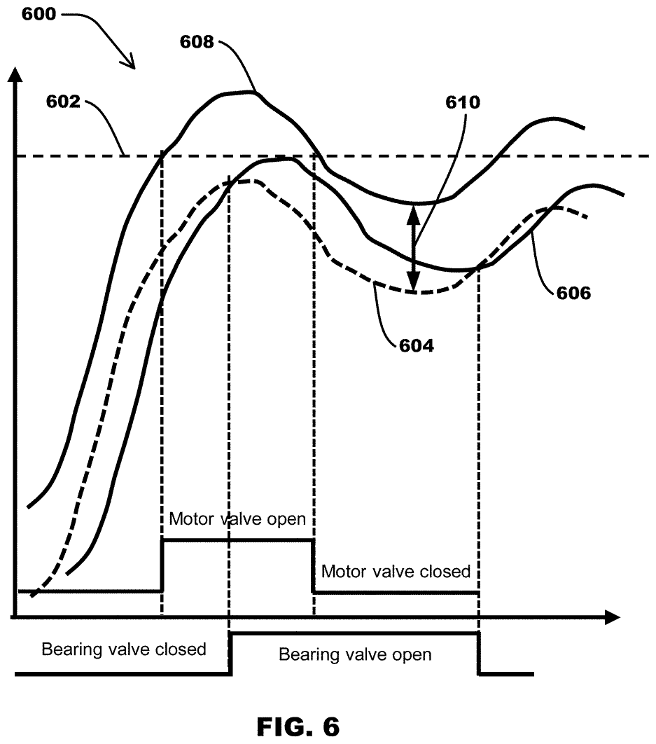

FIG. 6 is a graph 600 illustrating operation of the bearing coolant control valve 508 and the motor coolant control valve 510 according to an example control scheme or algorithm. In this control scheme, the motor coolant control valve 510 is controlled based on a fixed or set motor temperature set point, indicated by line 602, and the bearing coolant control valve 508 is controlled based on a variable bearing temperature set point, indicated by line 604. The temperature detected by the first temperature sensor 258 is illustrated by curve 606 in FIG. 6, and the temperature detected by the second temperature sensor 504 is illustrated by curve 608 in FIG. 6.

In this embodiment, the bearing temperature set point 604 is determined on an ongoing or a continuous basis (e.g., periodically or in real-time) based on the detected temperature 608 of the compressor housing 216 detected by the second temperature sensor 504. More specifically, the bearing temperature set point 604 is calculated or determined by subtracting an offset temperature 610 from the measured temperature 608 of the compressor housing 216. As shown in FIG. 6, for example, as the measured temperature 608 of the compressor housing 216 increases, the bearing temperature set point 604 increases by the same amount, but remains offset from the measured temperature 608 by the offset temperature 610. The offset temperature 610 can be any suitable offset temperature that enables the compressor 500 to function as described herein, including, for example and without limitation, in the range of 0° F. to 30° F., in the range of 0° F. to 25° F., in the range of 5° F. to 30° F., in the range of 5° F. to 20° F., in the range of 5° F. to 15° F., in the range of 10° F. to 25° F., and in the range of 10° F. to 20° F.

As shown in FIG. 6, when the detected temperature 608 of the compressor housing 216 exceeds the motor temperature set point 602, the controller 260 opens the motor coolant control valve 510 to supply additional coolant to the motor 234. The additional coolant supplied to the motor 234 results in the temperature of the compressor housing 216 decreasing after a period of time, resulting in the detected temperature 608 decreasing. When the detected temperature 608 of the compressor housing 216 decreases to a temperature below the motor temperature set point 602, the controller 260 closes the motor coolant control valve 510, reducing coolant flow to the motor 234. The temperature of the motor 234 and the compressor housing 216 thereby increases, as shown in FIG. 6.

Additionally, when the detected temperature 606 of the coolant return line 256 exceeds the bearing temperature set point 604, the controller 260 opens the bearing coolant control valve 508 to supply additional coolant to the bearings 220, 222, 224. The additional coolant supplied to the bearings 220, 222, 224 results in the temperature of coolant in the coolant return line 256 and the temperature of the coolant return line 256 decreasing after a period of time, resulting in the detected temperature 606 decreasing. When the detected temperature 606 of the coolant return line 256 decreases to a temperature below the bearing temperature set point 604, the controller 260 closes the bearing coolant control valve 508, reducing coolant flow to the bearings 220, 222, 224 The temperature of coolant at the coolant return line 256 increases as a result, as shown in FIG. 6. This cycle repeats during operation of the compressor 500. The motor temperature set point 602 and offset temperature 610 can be empirically determined prior to operation.

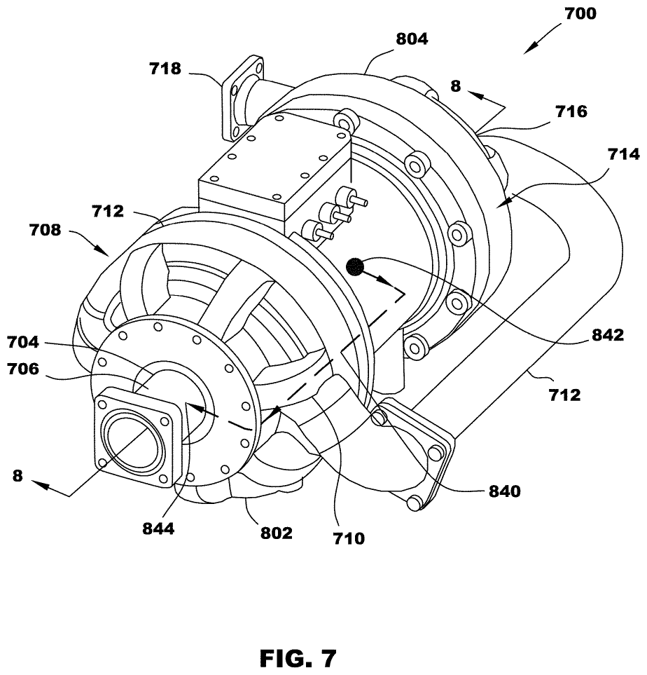

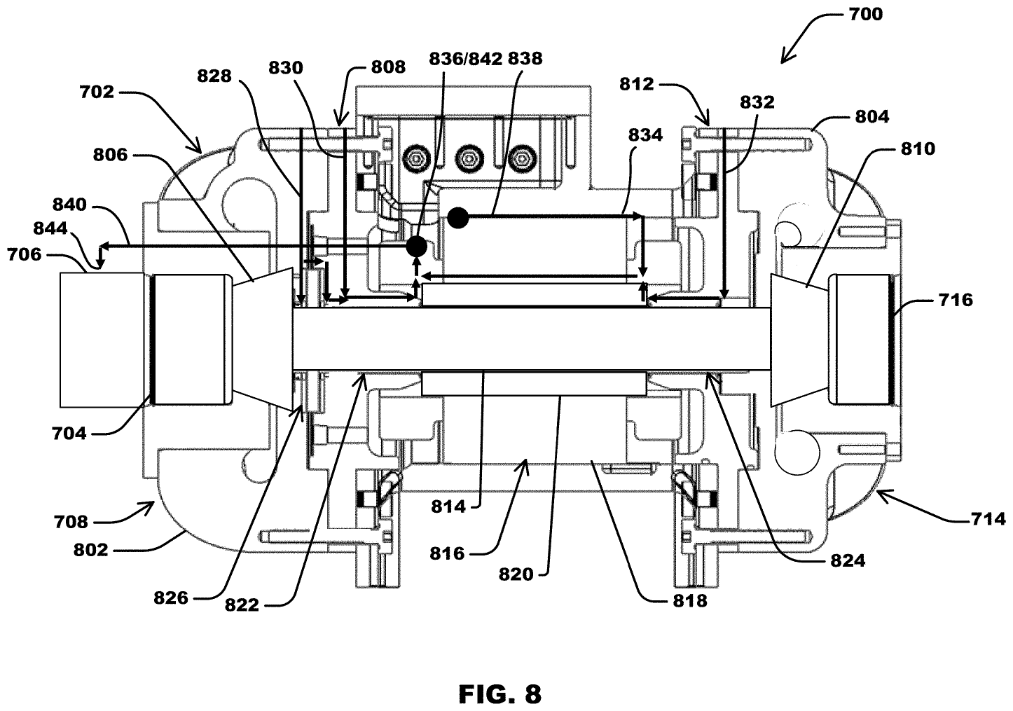

FIG. 7 is a perspective view of an example compressor 700 suitable for use in the refrigeration system 100 of FIG. 1 and the compressor cooling systems 200, 500 of FIGS. 2 and 5. FIG. 8 is a cross-sectional view of the compressor 700 of FIG. 7 taken along line 8-8. In the illustrated embodiment, the compressor 700 is a two-stage centrifugal compressor, although in other embodiments, the compressor 700 may include a single stage or more than two stages. In yet other embodiments, the compressor 700 may be a compressor other than a centrifugal compressor.

The compressor 700 generally includes a compressor housing 702 forming at least one sealed cavity within which each stage of refrigerant compression is accomplished. The compressor 700 includes a first refrigerant inlet 704 that receives refrigerant from a suction line 706 and introduces refrigerant vapor into a first compression stage 708, a first refrigerant exit 710, a refrigerant transfer conduit 712 to transfer compressed refrigerant from the first compression stage 708 to a second compression stage 714, a second refrigerant inlet 716 to introduce refrigerant vapor into the second compression stage 714, and a second refrigerant exit 718. The refrigerant transfer conduit 712 is operatively connected at opposite ends to the first refrigerant exit 710 and the second refrigerant inlet 716, respectively. The second refrigerant exit 718 delivers compressed refrigerant from the second compression stage 714 to a cooling system or refrigeration system (e.g., refrigeration system 100) in which the compressor 700 is incorporated.

With additional reference to FIG. 8, the compressor housing 702 includes a first housing end portion or cap 802 enclosing the first compression stage 708, and a second housing end portion or cap 804 enclosing the second compression stage 714. The first compression stage 708 and the second compression stage 714 are positioned at opposite ends of the compressor 700, but can also be located at the same end of the compressor 700. The first compression stage 708 includes a first impeller 806 configured to add kinetic energy to refrigerant entering via the first refrigerant inlet 704. The kinetic energy imparted to the refrigerant by the first impeller 806 is converted to increased refrigerant pressure (i.e., compression) as the refrigerant velocity is slowed upon transfer to a sealed cavity (e.g., a diffuser). Similarly, the second compression stage 714 includes a second impeller 810 configured to add kinetic energy to refrigerant transferred from the first compression stage 708 entering via the second refrigerant inlet 716. The kinetic energy imparted to the refrigerant by the second impeller 810 is converted to increased refrigerant pressure (i.e., compression) as the refrigerant velocity is slowed upon transfer to a sealed cavity (e.g., a diffuser). Compressed refrigerant exits the second compression stage 714 via the second refrigerant exit 718.

The first impeller 806 and second impeller 810 are coupled at opposite ends of a driveshaft 814. The driveshaft 814 is operatively coupled to a motor 816 positioned between the first impeller 806 and second impeller 810 such that the first impeller 806 and second impeller 810 are rotated at a rotation speed selected to compress the refrigerant to a pre-selected target (e.g., mass flow) exiting the second refrigerant exit 718. Any suitable motor may be incorporated into the compressor 700 including, but not limited to, an electrical motor. The example compressor 700 includes an electrical motor having a stator 818 connected to the compressor housing 702, and a rotor 820 connected to the driveshaft 814. An air gap (not labeled in FIG. 8) is defined between the stator 818 and the rotor 820 to allow coolant to flow therethrough. The driveshaft 814 is supported by first and second radial foil bearings 822, 824, and a thrust foil bearing 826. Additional details of the compressor 700, such as additional components and operation of the compressor 700, are described in U.S. Patent Application Publication No. 2020/0256347, the disclosure of which is incorporated herein by reference.

As shown in FIG. 8, the compressor housing 702 has a plurality of coolant flow channels 828, 830, 832, 834 defined therein that delivers coolant to the bearings 822, 824, 826 and the motor 816. The example compressor 700 includes a first coolant flow channel 828, a second coolant flow channel 830, a third coolant flow channel 832, and a fourth coolant flow channel 834. The first coolant flow channel 828 delivers coolant to the thrust bearing 826, the second coolant flow channel 830 delivers coolant to the first radial bearing 822, the third coolant flow channel 832 delivers coolant to the second radial bearing 824, and the fourth coolant flow channel 834 delivers coolant to the motor 816. The compressor housing 702 also defines a common coolant outlet port 836 in the illustrated embodiment. The common coolant outlet port 836 receives coolant from each of the plurality of coolant flow channels 828, 830, 832, 834.

The first coolant flow channel 828 extends radially inward through the first housing end portion 802, around the thrust bearing 826, axially along the driveshaft 814 between the first bearing housing 808 and the driveshaft 814, and radially outward to the common coolant outlet port 836. The second coolant flow channel 830 extends radially inward through the first bearing housing 808 to the first radial bearing 822, axially along the first radial bearing 822 and the driveshaft 814, and radially outward to the common coolant outlet port 836. The third coolant flow channel 832 extends radially inward through the second bearing housing 812 to the second radial bearing 824, axially along the second radial bearing 824 and the driveshaft 814, radially outward toward the air gap defined between the stator 818 and the rotor 820, axially through the air gap, and radially outward to the common coolant outlet port 836. The fourth coolant flow channel 834 extends helically around the stator 818 through a spiral groove 838 defined by the compressor housing 702. The fourth coolant flow channel 834 then extends radially inward to the air gap defined between the stator 818 and rotor 820, axially through the air gap, and then radially outward to the common coolant outlet port 836.

As shown in FIG. 8, the coolant flow channels 828, 830, 832, 834 can share common or overlapping portions of the compressor housing 702. For example, the first coolant flow channel 828 overlaps with and feeds into the second coolant flow channel 238 at the first radial bearing 822, and the third coolant flow channel 832 overlaps with and feeds into the fourth coolant flow channel 834 at the motor 816. Moreover, as shown in FIG. 8 and described above, the coolant flow channels 828, 830, 832, 834 within the example compressor housing 702 are arranged such that coolant flows through at least one of the coolant flow channels 828, 830, 832, 834, in series, across at least one of the bearings 822, 824, 826, through the motor 816, and to the common coolant outlet port 836. For example, the third coolant flow channel 832 delivers coolant to the second radial bearing 824 and the motor 816 (e.g., by flowing across the stator 818 and rotor 820), resulting in coolant absorbing heat from both the bearings 822, 824, 826 and the motor 816.

A coolant return line 840 (shown schematically in FIGS. 7 and 8) has an inlet 842 connected to the common coolant outlet port 836, and an outlet 844 connected to the suction line 706 to return coolant to a low-pressure side of the compressor 700. The suction line 706 is generally at a lower pressure than the coolant delivered to the compressor housing 702, which can be supplied from a relatively high pressure side of a refrigeration system in which the compressor 700 is incorporated, such as downstream of the condenser. As a result, a pressure differential exists between coolant at the coolant source and the suction line 706, and facilitates driving coolant through the plurality of coolant flow channels 828, 830, 832, 834.

Embodiments of the systems and methods described achieve superior results as compared to prior systems and methods associated with centrifugal compressor cooling systems. For example, the cooling circuits and associated coolant control valves and schemes disclosed herein provide continuous coolant to the bearings of the compressor, thereby providing protection to the bearings, while also allowing additional coolant to be supplied to the motor for additional cooling based on temperature feedback. Additionally, the cooling systems disclosed herein do not require the use of an external or additional liquid pump, and require little or few additional components, thereby providing a relatively simple, reliable compressor cooling system.

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing(s) shall be interpreted as illustrative and not in a limiting sense.

1. A compressor system comprising:
a centrifugal compressor comprising:
a housing;
a shaft rotatably supported in the housing by at least one bearing;
an impeller connected to the shaft; and
a motor operably connected to the shaft, wherein the housing has a plurality of coolant flow channels defined therein that delivers coolant to the at least one bearing and the motor; and
a cooling circuit comprising:
a coolant supply line connected to the compressor housing to deliver coolant to at least one of the plurality of coolant flow channels, the coolant supply line comprising a coolant control valve to control coolant flow through the coolant supply line;
a coolant return line connected to the compressor housing to receive coolant from the plurality of coolant flow channels and return coolant to a low-pressure side of the compressor;
a temperature sensor connected to the coolant return line to detect at least one of a temperature of the coolant return line and a temperature of coolant within the coolant return line; and
a controller connected to the temperature sensor and the coolant control valve, wherein the controller is configured to control the coolant control valve based on the temperature detected by the temperature sensor to control the supply of coolant to the compressor housing.

2. The compressor system of claim 1, wherein the temperature sensor is connected to an external surface of the coolant return line and detects a temperature of the external surface.

3. The compressor system of claim 1, wherein the compressor housing further defines a common coolant outlet port that receives coolant from each of the plurality of coolant flow channels, wherein the coolant return line has an inlet connected to the common coolant outlet port and an outlet connected to the low-pressure side of the centrifugal compressor.

4. The compressor system of claim 3, wherein at least one of the plurality of coolant flow channels is arranged such that coolant flows through the at least one coolant flow channel, in series, across the at least one bearing, through the motor, and to the common coolant outlet port.

5. The compressor system of claim 1, wherein the coolant supply line comprises a motor coolant supply line having an inlet connected to a coolant source and an outlet connected to the compressor housing, wherein the cooling circuit further comprises:
at least one bearing coolant supply line having an inlet connected to the motor coolant supply line upstream of the coolant control valve, and an outlet connected to the compressor housing to deliver the coolant to at least one of the plurality of coolant flow channels, wherein the at least one bearing coolant supply line is configured to continuously supply coolant to the compressor housing irrespective of a position of the coolant control valve.

6. The compressor system of claim 5, wherein at least one of the plurality of coolant flow channels is arranged such that coolant flows through the at least one coolant flow channel, in series, across the at least one bearing, through the motor, and to a common coolant outlet port defined by the compressor housing, wherein the at least one bearing coolant supply line is connected to the at least one coolant flow channel.

7. The compressor system of claim 1, wherein the centrifugal compressor comprises:
a first radial bearing that rotatably supports a first end of the shaft;
a second radial bearing that rotatably supports a second end of the shaft; and
a thrust bearing, wherein the plurality of coolant flow channels delivers coolant to each of the first radial bearing, the second radial bearing, and the thrust bearing.

8. The compressor system of claim 1, wherein the compressor housing defines a plurality of coolant inlet ports, each coolant inlet port connected to one of the plurality of coolant flow channels, wherein at least one of the coolant inlet ports comprises a metering orifice to limit the flow of coolant therethrough.

9. The compressor system of claim 1, wherein the coolant supply line is a main bearing coolant supply line and the coolant control valve is a bearing coolant control valve, the cooling circuit further comprising a plurality of bearing coolant supply lines connected to the main bearing coolant supply line to receive coolant therefrom, wherein the main bearing coolant supply line comprises a bypass line that allows coolant to bypass the bearing coolant control valve to provide a continuous flow of coolant to the compressor housing irrespective of a position of the bearing coolant control valve.

10. The compressor system of claim 9 further comprising a motor coolant supply line having an inlet connected to a coolant source and an outlet connected to the compressor housing, the motor coolant supply line comprising a motor coolant control valve and a bypass line that that allows coolant to bypass the motor coolant control valve to provide a continuous flow of coolant to the compressor housing irrespective of a position of the motor coolant control valve.

11. The compressor system of claim 10, wherein the temperature sensor is a first temperature sensor, the cooling circuit further comprising a second temperature sensor connected to the compressor housing to detect a temperature of the compressor housing, wherein the controller is connected to the second temperature sensor and is configured to control the motor coolant control valve based on the temperature detected by the second temperature sensor.

12. The compressor system of claim 11, wherein the second temperature sensor is connected to an external surface of the compressor housing.

13. A cooling system for a compressor, the cooling system comprising:
a coolant supply line comprising a coolant control valve to control coolant flow therethrough, the coolant supply line connectable to a housing of the compressor to deliver coolant to at least one of a plurality of coolant flow channels defined within the compressor housing;
a coolant return line connectable to the compressor housing to receive coolant from the plurality of coolant flow channels and return coolant to a low-pressure side of the compressor;
a temperature sensor connected to the coolant return line to detect at least one of a temperature of the coolant return line and a temperature of coolant within the coolant return line; and
a controller connected to the temperature sensor and the coolant control valve, wherein the controller is configured to control the coolant control valve based on the temperature detected by the temperature sensor to control the supply of coolant through the coolant supply line.

14. The cooling system of claim 13, wherein the temperature sensor is connected to an external surface of the coolant return line and detects a temperature of the external surface.

15. The cooling system of claim 14, wherein the coolant supply line comprises a motor coolant supply line having an inlet connected to a coolant source, wherein the cooling system further comprises:
at least one bearing coolant supply line connectable to the compressor housing to deliver the coolant to at least one of the plurality of coolant flow channels, wherein the at least one bearing cooling supply line has an inlet connected to the motor coolant supply line upstream of the coolant control valve and is configured to continuously supply coolant to the compressor housing irrespective of a position of the coolant control valve.

16. The cooling system of claim 13, wherein the coolant supply line is a main bearing coolant supply line and the coolant control valve is a bearing coolant control valve, the cooling system further comprising a plurality of bearing coolant supply lines connected to the main bearing coolant supply line to receive coolant therefrom, wherein the main bearing coolant supply line comprises a bypass line that allows coolant to bypass the bearing coolant control valve to provide a continuous flow of coolant to the compressor housing irrespective of a position of the bearing coolant control valve.

17. The cooling system of claim 16 further comprising a motor coolant supply line having an inlet connected to a coolant source and an outlet connectable to the compressor housing, the motor coolant supply line comprising a motor coolant control valve and a bypass line that that allows coolant to bypass the motor coolant control valve to provide a continuous flow of coolant to the compressor housing irrespective of a position of the motor coolant control valve.

18. The cooling system of claim 17, wherein the temperature sensor is a first temperature sensor, the cooling system further comprising a second temperature sensor connected to the compressor housing to detect a temperature of the compressor housing, wherein the controller is connected to the second temperature sensor and is configured to control the motor coolant control valve based on the temperature detected by the second temperature sensor.

19. The cooling system of claim 18, wherein the second temperature sensor is connected to an external surface of the compressor housing.

20. A refrigeration system comprising:
a compressor comprising:
a housing;
a shaft rotatably supported in the housing by at least one bearing;
an impeller connected to the shaft; and
a motor operably connected to the shaft, wherein the housing has a plurality of coolant flow channels defined therein that delivers coolant to the at least one bearing and the motor;
an evaporator;
a condenser;
an expansion device; and
a cooling circuit comprising:
a coolant supply line connected to the compressor housing to deliver coolant to at least one of the plurality of coolant flow channels, the coolant supply line comprising a coolant control valve to control coolant flow through the coolant supply line;
a coolant return line connected to the compressor housing to receive coolant from the plurality of coolant flow channels and return coolant to a low-pressure side of the compressor;
a temperature sensor connected to the coolant return line to detect at least one of a temperature of the coolant return line and a temperature of coolant within the coolant return line; and
a controller connected to the temperature sensor and the coolant control valve, wherein the controller is configured to control the coolant control valve based on the temperature detected by the temperature sensor to control the supply of coolant to the compressor housing.

21-26. (canceled)
